(19) United States
(12) Patent Application Publication
(10) Pub. No.: US 2005/0283636 A1
(43) Pub. Date: Dec. 22, 2005

(54) System and method for failure recovery in a cluster network

(75) Inventors: Bharath V. Vasudevan, Austin, TX (US); Sumankumar A. Singh, Pflugerville, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/846,028

(22) Filed: May 14, 2004

(51) Int. Cl. G06F 11/00

(52) U.S. Cl. 714/2

(57) ABSTRACT

A system and method for recovering from a failure in a cluster network is disclosed in which an instance of an application of a failed network node is initiated on a second network with data representative of the operating environment of the application of the failed network node.

### TECHNICAL FIELD

The present disclosure relates generally to the field of networks, and, more particularly, to a system and method for recovering from a failure in a network.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary with regard to the kind of information that is handled, bow the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

Computers, including servers and workstations, are often grouped in clusters to perform specific tasks. A server cluster is a group of independent servers that is managed as a single system and is characterized by higher availability, manageability, and scalability, as compared with groupings of unmanaged servers. A server cluster typically involves the configuration of a group of independent servers such that the servers appear in the network as a single machine or unit. Server clusters are managed as a single system, share a common namespace on the network, and are designed specifically to tolerate component failures and to support the addition or subtraction of components in the cluster in a transparent manner. At a minimum, a server cluster includes two or more servers, which are sometimes referred to as nodes, that are connected to one another by a network or other communication links.

A high availability cluster is characterized by a fault tolerant architecture cluster architecture in which a failure of a node is managed such that another node of the cluster replaces the failed node, allowing the cluster to continue to operate. In a high availability cluster, an active node hosts an application, while a passive node waits for the active node to fail so that the passive node can host the application and other operations of the failed active node. To restart the application of the failed node on the passive node, the application must typically reaccess resources and data that was previously held by and accessible to the application on the failed active node. These resources include various data structures that describe the run-state of the application, the address space occupied and accessible by the application, the list of open files, and the priority of the process, among other resources. The process of reaccessing application resources at the passive node produces an undesirable period of downtime during the failover of the affected application from the active node to the passive or backup node. During the period in which the affected application is being established on the passive node, a user cannot access the affected application. In addition, all incomplete transactions being processed by the application at the time of the initiation of the failover process are lost and will have to be resubmitted and reprocessed.

### SUMMARY

In accordance with the present disclosure, a system and method for recovering from a failure in a cluster node is disclosed. When a node of a cluster fails, a second instance of a software application running on the first node is created on another cluster node. The software application running on the second node is provided with and begins operation on the basis of a data structure that includes data elements representative of the operating state of the software application running on the first node of the cluster. The data structure is a snapshot of the operating state of the first node and is saved to a storage location accessible by all of the nodes of the cluster.

A technical advantage of the disclosed system and method is a failure recovery technique that provides for the rapid initiation and operation in a second node of a software application running on the failed first node. Because the software application of the second node has access to a data structure representative of the operating environment of the software application of the first node, the software application of the second node need not recreate these resources as part of its application initiation sequence. Because of this advantage, the software application of the second node can begin operation with reduce downtime. Because the system and method disclosed herein results in less downtime, fewer transactions are missed during the transition from the software application of the first node to the software application of the second node.

Another technical advantage of the system and method disclosed herein is the disclosed system and method may be implemented such that the saved data structure is stored in multiple locations in the network. In this manner, because the data structure can be stored in multiple locations, the failure of both the first node together with another storage location need not compromise the failure recovery methodology disclosed herein. Another technical advantage is that the system and method disclosed herein may be implemented so that the snapshot of the representative data structure is recorded or captured on a periodic basis or on an event-drive basis in connection with changes to the operating environment of the software application of the first node. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a cluster network;

FIG. 2 is a flow diagram of a cluster failover method; and

FIG. 3 is a diagram of a cluster network following the completion of a cluster failover operation.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a person computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. An information handling system may comprise one or more nodes of a cluster network.

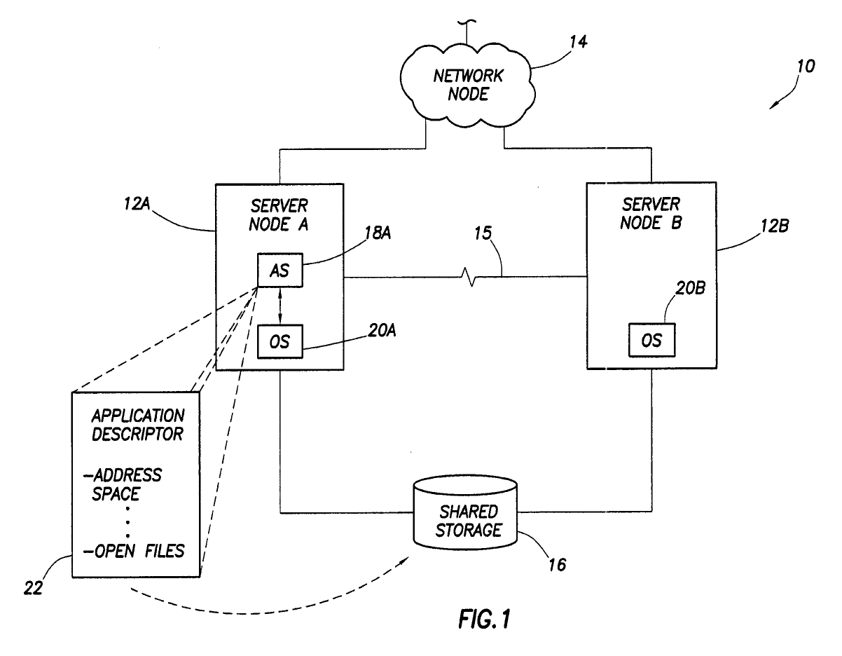

Shown in FIG. 1 is a diagram of a two-node server cluster network, which is indicated generally at 10. Cluster network 10 is an example of a highly available cluster implementation. Server cluster network 10 includes server node 12A and server node 12B that are interconnected to one another by a heartbeat or communications link 15. Each of the server nodes 12 is coupled to a network 14, which represents a connection to a communications network served by the server nodes 12. Each of the server nodes 12 is coupled to a shared storage unit 16. Server node A includes an instance of application software 18A and an operating system 20A. Although server node A is shown as running a single instance of application software 18A, it should be recognized that a server node may support multiple applications, including multiple instances of a single application. Server node B includes an operating system 20B. In the example of FIG. 1, server node A is the active node, and server node B is the passive node. Server node B replaces server node A in the event of a failure in server node A.

As indicated in FIG. 1, each application is associated with an application descriptor 22. An application descriptor is a set of data elements that reflect the then current state of the application. The application descriptor may include an indicator of the addressable space of the application, a list of open files being managed by the application, and the status of the application relative to the operating system's processing queue. The application description may also include a the content of registers or the memory stacks being accessed by the processor. In sum, the application descriptor is a set of data that reflects the current, dynamic operating state of the application.

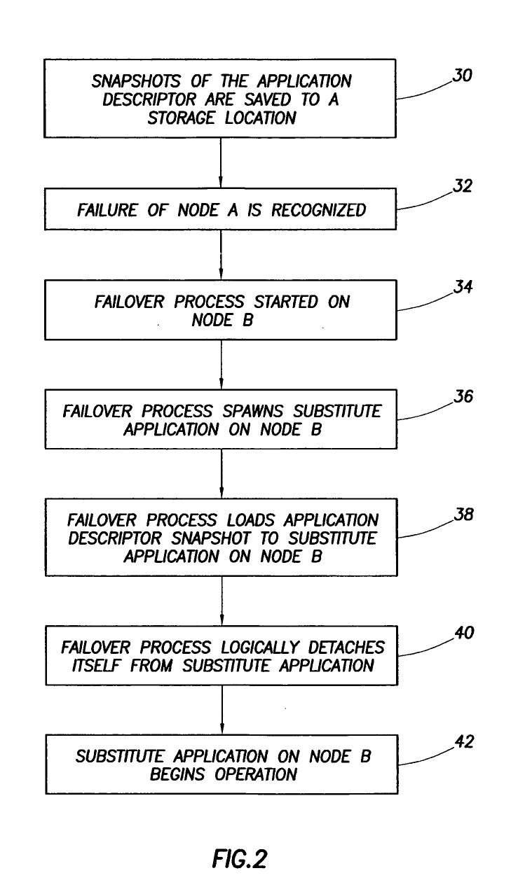

A flow diagram of the cluster failover method is shown in FIG. 2. At step 30, a snapshot or successive snapshots of the application descriptor are saved to a storage location. The application descriptor 22 for application software 18A of server node 12A is captured and saved to a storage location. The application descriptor for the application is saved on a snapshot basis, meaning that the content is specific to the time of the capture of the application descriptor. The storage location may be any storage location accessible by the passive node, which in this example is server node B. The application description may be stored in shared storage 16 or in any other storage location accessible by server node B, including server node B itself. The application descriptor may be simultaneously stored in multiple storage locations in effort to protect the integrity of the application descriptor from the simultaneous failure of any single storage location. The dotted arrow of FIG. 1 indicates that the application descriptor of the example of FIG. 1 is saved to shared storage 16.

With respect to frequency and timing of the capture of the snapshot of the application descriptor. A snapshot of the application descriptor may be taken periodically or according to a predefined schedule. As an example of a period snapshot capture, a snapshot may be taken every thirty seconds during any period in which the associated application is active. In addition to or as an alternative to a periodic capture of the application descriptor, the capture of a snapshot of the application descriptor may be event driven. A snapshot of the application descriptor may be taken when any or certain predefined elements of the application descriptor are modified. In this event-driven mode, a change to the application description would result in an updated snapshot of the application descriptor being saved to the memory location.

At step 32 of FIG. 2, the failure of server node A is recognized at server node B. The technique described herein is especially applicable for those failures that do not affect the integrity of the operating environment of the application of the failed node. Failures of this type include storage failures and communication interface failures. At step 34, a failover process is initiated at server node B to cause server node B to substitute for server node A. The failover process is a recovery application that serves to recognize a failure in an active node and initiate the activation of a passive node in replacement of the failed active node. The failover process spawns at step 36 a substitute application on server node B. The substitute application is intended to replace application software 18A of failed server node A. At step 38, the failover process retrieves the most recent application descriptor snapshot for application 18A and saves the application descriptor to the memory space for the substitute application spawned on server node B. At step 40, the failover process logically detaches from the substitute application, thereby allowing the substitute application to begin operations at step 42.

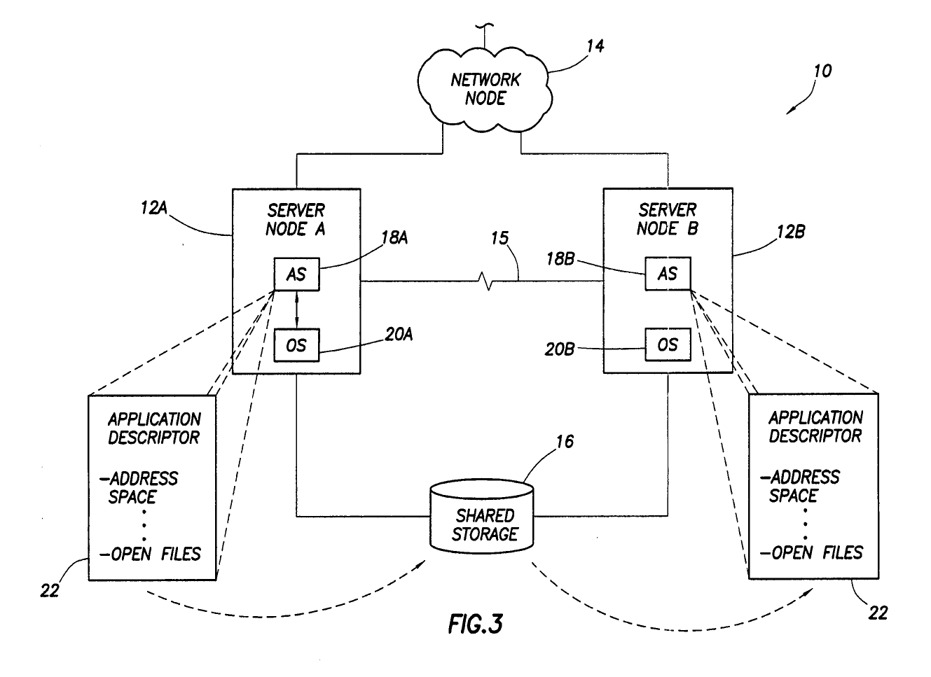

Following the completion of the steps of FIG. 2, the substitute application of server node B operates in place of the application of failed server node A. The transition of application software 18 from server node A to server node B occurs with reduced downtime, as the substitute application of server node B is not forced to recreate the operating resources of application 18A. Instead, a recent snapshot of the operating resources of application software 18A are provided to the substitute application in the form of the saved application description 22, allowing the application to quickly enter an operating state without the downtime typically associated with the creation of an instance of a software application in a failover environment. Shown in FIG. 3 is a diagram of the two-node cluster network 10 following the completion of the steps of FIG. 2. The substitute application software 18B of server node B is shown as having access to application descriptor 22, which is shown by the dashed line as being accessed by server node B from shared storage 16.

The failure recovery technique disclosed herein has been described with respect to a single instance of application software that is being replicated upon the failure of an active node to a passive node. The technique described herein may be employed with any number of instances of application software present in the active node. In the case of multiple instances of application software present on the active node, an application descriptor is created for each instance of application software and, as described with respect to FIG. 2, each application descriptor is stored in a storage location accessible by the passive node.

The recovery failure techniques disclosed herein is not limited in its use to clusters having only two nodes. Rather, the technique described herein may be used with clusters having multiple nodes, regardless of their number. Although a dual node example of the technique is described herein, the failure recovery system and method of the present disclosure may be used in cluster networks having any combination of single active nodes, single passive nodes, multiple active nodes, and multiple passive nodes. Although the present disclosure has been described in detail, it should be understood that various changes, substitutions, and alterations can be made hereto without departing from the spirit and the scope of the invention as defined by the appended claims.

1. A method for recovering from the failure of a node in a network, comprising the steps of:
saving to a storage location data representative of the operating environment of a first application that is operating on a first node of the network;
recognizing the failure of the first node of the network;
initiating a second application on a second node of the network;
providing the saved data from the storage location to the second application; and
operating the second application on the basis of the data, whereby the second application is able to operate on the basis of the data and is able to begin operation without recreating the data.

2. The method for recovering from the failure of a node in a network of claim 2, wherein the step of saving to a storage location comprises the step of periodically saving the data at a predefined interval.

3. The method for recovering from the failure of a node in a network of claim 2, wherein the step of saving to a storage location comprises the step of saving the data upon modification of to the operating environment of the first application.

4. The method for recovering from the failure of a node in a network of claim 2, wherein the storage location is the shared storage of the network.

5. The method for recovering from the failure of a node in a network of claim 2, wherein the storage location is the second node of the network.

6. The method for recovering from the failure of a node in a network of claim 2, wherein the storage location comprises both the shared storage of the network and the second node of the network.

7. The method for recovering from the failure of a node in a network of claim 2, wherein the data comprises a snapshot of the operating environment of the first application.

8. A network, comprising
a first node;
a first instance of a software application running on the first node;
a second node;
a storage location accessible by the first node and the second node, the storage location storing therein a data structure having data elements representative of the operating environment of the first instance of the software;
wherein a second instance of the software application is initiated on the second node in the event of a failure of the first node, the second instance of the software application operable to be initiated on the basis of the data elements stored in the storage location.

9. The network of claim 8, wherein the data elements of the data structure comprise a snapshot of the operating environment of the first instance of the software application.

10. The network of claim 9, wherein the storage location is the second node.

11. The network of claim 9, wherein the storage location is the shared storage of the network.

12. The network of claim 9, wherein the storage location comprises both the second node and the shared storage of the network.

13. The network of claim 9, wherein the data elements of the data structure are representative of the addressable memory space of the first instance of the application.

14. The network of claim 9, wherein the data elements of the data structure are representative of the open files of the first instance of the application.

15. A method for recovering from a failure in a first node of a network, the first node having running thereon a first instance of a software application, comprising the steps of:
storing to a storage location a data elements representative of the operating state of the first instance of the software application;
recognizing the failure of the first node;
initiating a second instance of the software application in a second node of the network;
providing the second instance of the software application with the stored data elements;
running the second instance of the software application on the basis of the stored data elements, whereby the second instance of the software application may begin operation without recreating the data elements.

16. The method for recovering from a failure in a first node of a network of claim 15, wherein the data elements representative of the operating state of the first instance of the software application comprise a snapshot of the operating state of the first instance of the software application.

17. The method for recovering from a failure in a first node of a network of claim 16, wherein the step of storing to a storage location a data elements representative of the operating state of the first instance of the software application comprises the step of periodically storing to the storage location a snapshot of the operating state of the first instance of the software application.

18. The method for recovering from a failure in a first node of a network of claim 16, wherein the step of storing to a storage location a data elements representative of the operating state of the first instance of the software application comprises the step of storing to the storage location a snapshot of the operating state of the first instance of the software application upon the modification of the operating state of the first instance of the software application.

19. The method for recovering from a failure in a first node of a network of claim 16, wherein the storage location is shared storage of the network.

20. The method for recovering from a failure in a first node of a network of claim 16, wherein the storage location is the second node of the network.
